(19) United States
(12) Patent Application Publication
(10) Pub. No.: US 2024/0377671 A1
(43) Pub. Date: Nov. 14, 2024

(54) Display Device and Fixed Structure Set

(71) Applicant: Jet Optoelectronics Co., Ltd., Taipei City (TW)

(72) Inventors: Ming-Te Hung, Taipei City (TW); Wen-Ta Lee, Taipei City (TW)

(21) Appl. No.: 18/448,582

(22) Filed: Aug. 11, 2023

(30) Foreign Application Priority Data
May 10, 2023 (TW) 112117373

(51) Int. Cl. G02F 1/1333

(52) U.S. Cl. CPC G02F 1/133317; G02F 1/133314; G02F 1/133322; G02F 1/133325; G02F 2201/46

(57) ABSTRACT

A display device and a fixed structure set are provided. The display device includes a middle frame, a display panel, a plurality of first fixed structure sets and at least one second fixed structure set. The middle frame has a first surface and a second surface opposite to the first surface. The display panel is disposed on the first surface. The plurality of first fixed structure sets are configured to fix the display panel on the middle frame. The at least one second fixed structure set is configured to fix the display panel on the middle frame, and the fixing structure of the first fixed structure set is different from the fixing structure of the second fixing structure set. The display device and the fixed structure set can improve the strength of the display and avoid display problems and the like by the above configuration.

### CROSS-REFERENCE TO RELATED APPLICATION

This application claims the priority and benefit of Taiwan Patent Application No. 112117373 filed on May 10, 2023 to the TIPO, the disclosure of which is incorporated by reference in its entirety as if fully set forth herein.

### TECHNICAL FIELD

The present invention relates to a display device, and more particularly, to a display device and a fixed structure set to improve display problems of the display device by using a specific assembly scheme.

### BACKGROUND

In related art, a MURA effect extensively occurs in a screen. Since the cause of the occurrence has a directly proportional relation with uneven force applied to the screen, removing the residual stress of the screen is an important issue in designing the mechanism of a display device.

Recently, lots of electronic devices are composed of different assembly components. For example, in regard to a display device using various technological products, a display panel is assembled on a structurally reinforced middle frame during a production process, and thereafter, a front cover plate and a rear cover plate are assembled to the middle frame. Since the above-listed components are assembled to the middle frame, a multi-level fixation may cause severe stress deformation, and the deformation of the middle frame may exert an effect of generating the MURA effect on a liquid crystal display module (LCD module, LCM) of a screen display device.

In conclusion, the inventor of the present invention has considered and designed a display device and a fixed structure set, so as to improve the deficiencies of the related art and increase the industrial applicability.

### SUMMARY

An object of the present invention is to provide a display device and a fixed structure set in order to solve the above-described conventional problems.

In order to achieve the above object, the present invention provides a display device including a middle frame, a display panel, a plurality of first fixed structure sets and at least one second fixed structure set. The middle frame has a first surface and a second surface opposite to the first surface. The display panel is disposed on the first surface. The first fixed structure sets are configured to fix the display panel onto the middle frame. The at least one second fixed structure set is configured to fix the display panel on the middle frame and the first fixed structure set has a fixing configuration different from a fixing configuration of the second fixing structure set.

Preferably, the second fixed structure set includes a panel side fixing unit and a middle frame side fixing module; the panel side fixing unit is disposed on the display panel to face a surface of the first surface, and the middle frame side fixing module is disposed on the middle frame to correspond to the panel side fixing unit. The panel side fixing unit includes a positioning member, and a first positioning section is formed at one end of the positioning member away from the display panel. The middle frame side fixing module includes a mounting portion and a fixing member, the positioning member and the fixing member are disposed on both sides of the mounting portion facing each other, respectively, and the fixing member fixes the first positioning section.

Preferably, the mounting portion includes a cut-out opening and at least one fastening hole, in which the cut-out opening is formed to penetrate the first surface and the second surface to allow the positioning member to pass through, and the at least one fastening hole is disposed on the second surface and adjacent to the cut-out opening. The fixing member has a second positioning section and a circlelike hole, the fixing member is disposed on the second surface, the second positioning section is fixed to the first positioning section, and the fixing member is fixedly attached to the middle frame by a fastening member passing through the circlelike hole and fastened to the fastening hole.

Preferably, the cut-out opening has a width greater than a thickness of the positioning member, and the circlelike hole has an elongated elliptical shape.

Preferably, the positioning member is an upright plate, the positioning member is disposed vertically from the display panel toward the first surface, the first positioning section includes a through-hole, the second positioning section includes a protruding pillar, and the protruding pillar of the second positioning section is configured to be inserted into the through-hole of the first positioning section.

Preferably, the fixing member has an L-shaped structure, and the middle frame side fixing module includes an inclined surface section. The inclined surface section is disposed on the second plane, the inclined surface section gradually protrudes from the fastening hole toward the cut-out opening on the second surface, and a first end of the inclined surface section protruding from the second surface is parallel to a wall surface of the cut-out opening.

Preferably, the fastening hole is formed in the inclined surface section and the fastening hole is adjacent to a second end of the inclined surface section, in which the second end is opposite to the first end.

Preferably, the number of the first fixed structure set is at least three, and the at least three first fixed structure sets and the at least one second fixed structure set are disposed along four rectangular vertices.

In order to achieve the above object, the present invention further provides a fixed structure set for fixing the display panel to the middle frame. The fixed structure set includes a panel side fixing unit and a middle frame side fixing module. The panel side fixing unit is disposed on the display panel, and the middle frame side fixing module is disposed on the middle frame to correspond to the panel side fixing unit. The panel side fixing unit includes a positioning member, in which a first positioning section is formed at one end of the positioning member away from the display panel. the middle frame side fixing module is disposed on the middle frame to correspond to the panel side fixing unit, the middle frame side fixing module includes a mounting portion and a fixing member, the positioning member and the fixing member are disposed on both sides of the mounting portion facing each other, respectively, and the fixing member fixes the first positioning section.

Preferably, the mounting portion includes a cut-out opening and at least one fastening hole, in which the cut-out opening is formed to penetrate both surfaces of the middle frame to allow the positioning member to pass through, and the at least one fastening hole is disposed on a surface of the middle frame away from the display panel and is adjacent to the cut-out opening. The fixing member has a second positioning section and a circlelike hole, the fixing member is disposed on the surface of the middle frame away from the display panel to correspond to the cut-out opening, the second positioning section is fixed to the first positioning section, and the fixing member is fixedly attached to the middle frame by a fastening member passing through the circlelike hole and fastened to the fastening hole.

Preferably, the cut-out opening has a width greater than a thickness of the positioning member, and the circlelike hole has an elongated elliptical shape.

Preferably, the positioning member is an upright plate, the positioning member is disposed vertically from the display panel toward the middle frame, the first positioning section includes a through-hole, the second positioning section includes a protruding pillar, and the protruding pillar of the second positioning section is configured to be inserted into the through-hole of the first positioning section.

Preferably, the fixing member has an L-shaped structure, and the middle frame side fixing module includes an inclined surface section. The inclined surface section is disposed on a surface of the middle frame away from the display panel, the inclined surface section gradually protrudes from the fastening hole toward the cut-out opening on the surface, and a first end of the inclined surface section protruding from the surface is parallel to the wall surface of the cut-out opening.

Preferably, the fastening hole is formed in the inclined surface section and the fastening hole is adjacent to a second end of the inclined surface section, in which the second end is opposite to the first end.

Hereinafter, the technical features of the present invention will be described in detail with accompanying drawings according to specific embodiments in order for those skilled in the art to easily understand the objects, technical features, and effects of the present invention.

### BRIEF DESCRIPTION OF THE DRAWING

Hereinafter, embodiments of the present invention will be briefly described with reference to the necessary accompanying drawings in order to more clearly describe the technical solutions of the embodiments of the present invention. It is apparent that the drawings shown below are merely for illustrating some embodiments of the present invention, and those skilled in the art may obtain other drawings based on the above drawings.

FIG. 1 is a schematic diagram showing the structure of a display device of the present invention.

FIG. 2 is a schematic diagram showing a first configuration of a second fixed structure set of the display device of the present invention.

FIG. 3 is a schematic diagram showing a second configuration of the second fixed structure set of the display device of the present invention.

FIG. 4 is a schematic diagram showing n assembled state of the second fixed structure set of the display device of the present invention.

FIG. 5 is a schematic diagram showing a first embodiment of the second fixed structure set of the display device of the present invention.

FIG. 6 is a schematic diagram showing a second embodiment of the second fixed structure set of the display device of the present invention.

### DETAILED DESCRIPTION

Advantages, features and technical solutions to be achieved according to the present invention will be more easily understood by describing in more detail the accompanying drawings and the embodiments as reference examples. Further, the present invention may be implemented in various forms and will not be construed as being limited only to the embodiments described herein. Whereas, for those skilled in the art, the embodiments will be provided with a more thorough understanding of the disclosure and the scope of the present invention will be fully delivered. Further, the present invention will be subject to the following claims.

It is noted that terms such as “first” and “second” may be used herein to describe various components, members, regions, sections, layers, and/or sites. However, the components, members, regions, sections, layers and/or sites are not limited thereto. The above terms are only used to distinguish one component, member, region, section, layer and/or site from another component, member, region, section, layer and/or site.

Unless otherwise defined, all terms (including technical and scientific terms) used herein may have the same meanings as commonly understood by those skilled in the art. It is also noted that the terms such as commonly used dictionary definitions will be interpreted to have definitions consistent with meanings in the context of the relevant art and the present invention, and will not to be interpreted in an idealized or overly formal sense unless explicitly defined herein.

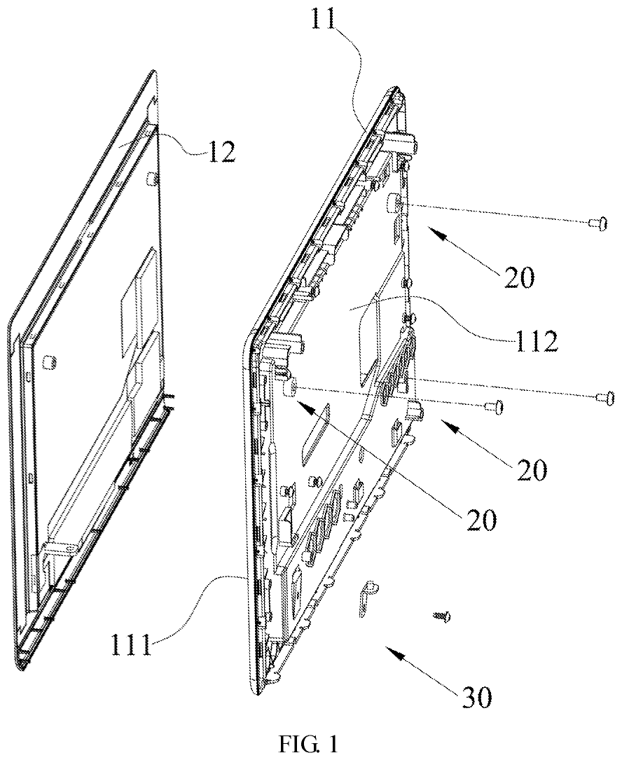

FIG. 1 is a schematic diagram showing the structure of a display device of the present invention. As shown in the drawings, the display device 1 of the present invention includes a middle frame 11, a display panel 12, a plurality of first fixed structure sets 20, and at least one second fixed structure set 30.

The middle frame 11 may have the nature of not easy to be deformed, i.e., limited amount of deformation. The middle frame 11 has a first surface 111 and a second surface 112 opposite to each other. The display panel 12 refers to a display panel known or generally used by those skilled in the art, and is disposed on the first surface 111. The first fixed structure sets 20 are configured to fix the display panel 12 to the middle frame 11. Particularly, the first fixed structure set 20 is a technical means known to or generally used by those skilled in the art. For example, the first fixed structure set 20 may include a pillar disposed on the display panel 12 and having a screw hole and a hole disposed on the middle frame 11 and formed with a through-hole, and accordingly, a screw is fastened to the screw hole through the through-hole, so that the display panel 12 is fixed to the middle frame 11. In addition, in the above manner, it is preferable that the pillar may abut against a bottom surface of the hole.

The second fixed structure set 30 is configured to fix the display panel 12 to the middle frame 11, and a fixing configuration of the first fixed structure set 20 is different from a fixing configuration of the second fixed set structure 30.

Preferably, the number of the first fixed structure sets may be at least three. The at least three first fixed structure sets 20 and the at least one second fixed structure set 30 are disposed along four vertices of a rectangle. The display device 1 of the present invention uses a fixing scheme according to technical means known to or generally used by those skilled in the art in order to achieve the attachment between the display panel 12 and the middle frame 11 at the three fixed points where the first fixed structure sets 20 are positioned. In addition, the three fixed points may form a plane, so that it is possible to ensure that the display device 1 itself of the present invention is flattened and no residual internal stress is present. In addition, the second fixed structure set 30 having a predetermined structural arrangement is additionally used, and accordingly, the display panel 12 is locked to the middle frame 11 while a gap is maintained. Thus, under the condition that the display panel 12 is firmly fixed to the middle frame 11, the display panel 12 is prevented from being stressed at the fixed point of the second fixed structure set 30, so as to maximally ensure a state in which no internal stress exists in the display panel 12 itself. Accordingly, the display device 1 of the present invention can prevent the MURA effect from occurring in a liquid crystal display module (LCD module, LCM) of a screen display device due to deformation of the middle frame 11.

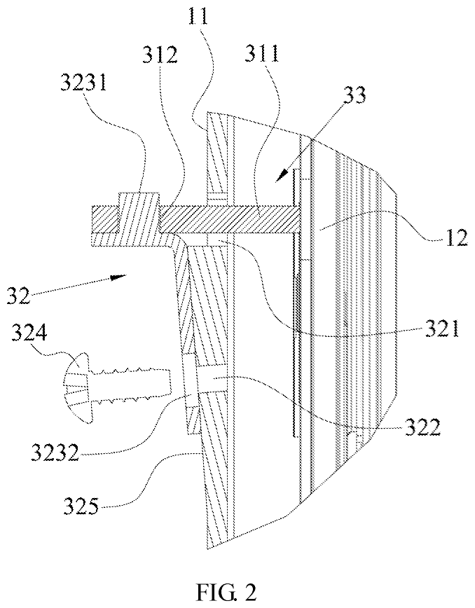

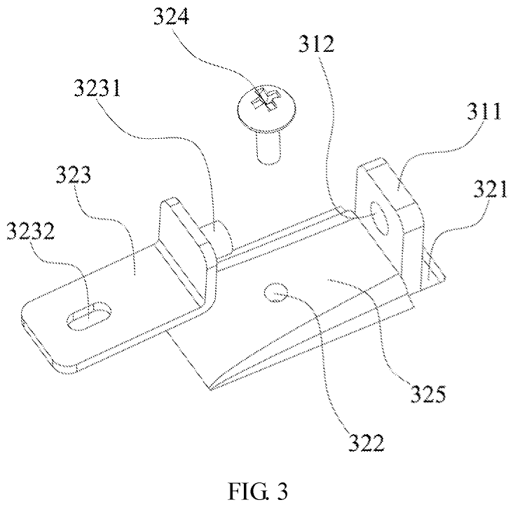

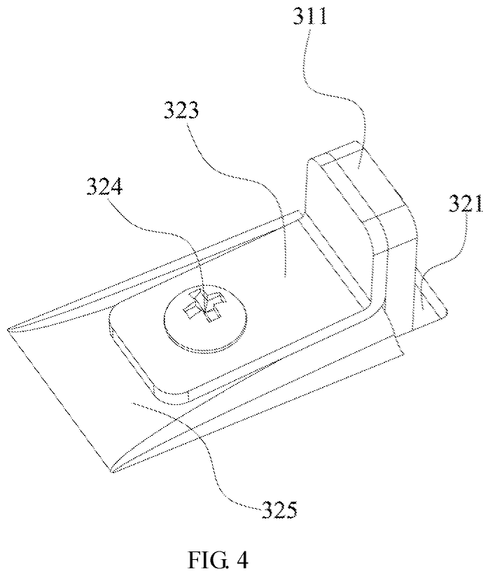

Referring to FIGS. 2 to 4 together with FIG. 1. FIG. 2 is a schematic diagram showing a first configuration of a second fixed structure set of the display device of the present invention. FIG. 3 is a schematic diagram showing a second configuration of the second fixed structure set of the display device of the present invention. FIG. 4 is a schematic diagram showing n assembled state of the second fixed structure set of the display device of the present invention.

As shown in the drawings, the second fixed structure set 30 will be further described. The second fixed structure set 30 includes a panel side fixing unit 31 and a middle frame side fixing module 32, in which the panel side fixing unit 31 is disposed on the display panel 12 to face the surface of the first surface 111, and the middle frame side fixing module 32 is disposed on the middle frame 11 to correspond to the panel side fixing unit 31.

The panel side fixing unit 31 includes a positioning member 311. The positioning member 311 may be formed of a metal material, and a first positioning section 312 is formed at one end of the positioning member 311 away from the display panel 12. Preferably, the positioning member 311 may be a vertical plate member vertically disposed from the display panel 12 toward the first surface 111.

The middle frame side fixing module 32 includes a mounting portion and a fixing member 323. The positioning member 311 and the fixing member 323 are respectively disposed on both sides of the mounting portion facing each other, and the fixing member 323 fixes the first positioning section 312. The mounting portion includes a cut-out opening 321, at least one fastening hole 322 and an inclined surface section 325. The cut-out opening 321 is formed to penetrate the first surface 111 and the second surface 112 to allow the positioning member 311 to pass through. In other words, the cut-out opening 321 may have a shape of a rectangular cut-out opening. The at least one fastening hole 322 is disposed on the second surface 112 and adjacent to the cut-out opening 321. In this embodiment, one fastening hole 322 is taken as an example, however, the present invention is not limited thereto. Particularly, a geometric center of the cut-out opening 321 and a geometric center of the fastening hole 322 may be preferably positioned on the same straight line. According to the drawings of the present embodiment, it appears as a straight line in the vertical direction, however, the configuration may be modified according to practical application. Therefore, the present invention is not limited thereto.

The fixing member 323 may be formed of a metal material, and have an approximately L-shaped structure. The fixing member 323 has a second positioning section 3231 and a circlelike hole 3232. In addition, the second positioning section 3231 is disposed on a short arm of the fixing member 323 having the L-shaped structure, and the circlelike hole 3232 is disposed on a long arm of the fixing member 323 having the L-shaped structure. The inclined surface section 325 is disposed on the second surface 112, in which the inclined surface section 325 gradually protrudes from the fastening hole 322 toward the cut-out opening 321 on the second surface 112, and a first end of the inclined surface section 325 protruding from the second surface 112 is parallel to a wall surface of the cut-out opening 321. In addition, the fastening hole 322 is formed in the inclined surface section 325 and the fastening hole 322 is adjacent to a second end of the inclined surface section 325, in which the second end is opposite to the first end.

When the fixing member 323 is disposed on the second surface 112, the second positioning section 3231 is fixed to the first positioning section 312. Preferably, the first positioning section 312 may be a through-hole such as a triangular hole, a rectangular hole or a circular hole. In this embodiment, a circular hole is exemplarily illustrated, however, the present invention is not limited thereto. In addition, the second positioning section 3231 may be a protruding pillar such as a triangular pillar, a rectangular pillar or a circular pillar. In this embodiment, a circular pillar is exemplarily illustrated, however, the present invention is not limited thereto. Thus, fixing the second positioning section 3231 to the first positioning section 312 corresponds to, for example, inserting the protruding pillar into the through-hole. The fastening member 324 using a screw known to or generally used by those skilled in the art is fastened to the fastening hole 322 through the circlelike hole 3232. Accordingly, the display panel 12 may be prevented from being stressed at the locking points of the second fixed structure set 30, so as to maximally ensure a state in which no internal stress exists in the display panel 12 itself.

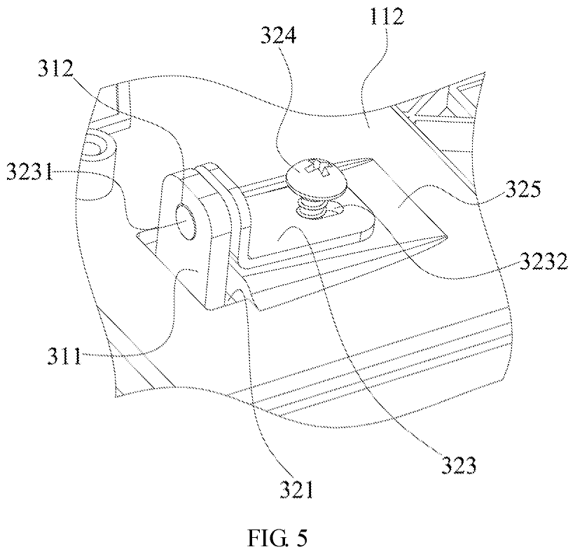

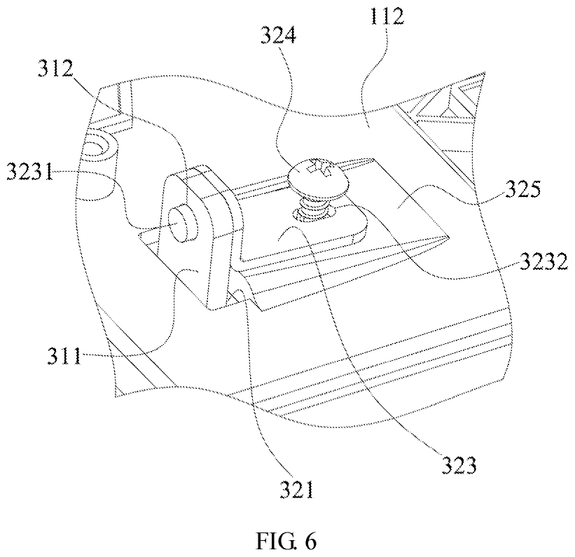

Referring to FIGS. 5 and 6 together with FIGS. 1 to 4. FIGS. 5 and 6 are schematic views showing the first embodiment and the second embodiment of the second fixed structure set of the display device of the present invention, respectively.

As shown in the drawings, preferably, the cut-out opening 321 has a width greater than a thickness of the positioning member 311, and the circlelike hole 3232 has an elongated elliptical shape. In other words, the elongated elliptical hole 3232 and the inclination of the inclined surface section 325 provide elasticity to adjust tension in which the display panel 12 is fixed to the middle frame 11 by using the second fixed structure set 30. When the fastening member 324 comes into close contact with one end of the second positioning section 3231 within the elongated elliptical hole 3232, pressure for contracting the display panel 12 inward may be provided, and when the fastening member 324 moves away from the end of the second positioning section 3231 within the elongated elliptical hole 3232, outward pressure may be applied to the display panel 12. The above manner can achieve the purpose of adjusting and relieving the internal stress of the display panel 12 and suppressing the occurrence of the MURA effect.

The fixed structure set according to the present invention is the same as or similar to the second fixed structure set of the display device of the present invention. In other words, details of the fixed structure set of the present invention have already been described in the display device of the present invention. Thus, identical or similar description will not be repeated herein.

The above description is only for illustrative purpose and is not restrictive. All modifications and changes within the scope without departing from the spirit of the present invention are included in the claims appended hereto.

1. A display device comprising:
a middle frame having first and second surfaces opposite to each other;
a display panel disposed on the first surface;
a plurality of first fixed structure sets configured to fix the display panel to the middle frame; and
at least one second fixed structure set configured to fix the display panel to the middle frame, in which the first fixed structure set has a fixing configuration different from a fixing configuration of the second fixing structure set.

2. The display device of claim 1, wherein the second fixed structure set includes a panel side fixing unit and a middle frame side fixing module, the panel side fixing unit is disposed on the display panel to face a surface of the first surface, the panel side fixing unit includes a positioning member, a first positioning section is formed at one end of the positioning member away from the display panel, the middle frame side fixing module is disposed on the middle frame to correspond to the panel side fixing unit, the middle frame side fixing module includes a mounting portion and a fixing member, the positioning member and the fixing member are disposed on both sides of the mounting portion facing each other, respectively, and the fixing member fixes the first positioning section.

3. The display device of claim 2, wherein the mounting portion includes a cut-out opening and at least one fastening hole, in which the cut-out opening is formed to penetrate the first surface and the second surface to allow the positioning member to pass through, the at least one fastening hole is disposed on the second surface and adjacent to the cut-out opening, the fixing member has a second positioning section and a circlelike hole, the fixing member is disposed on the second surface, the second positioning section is fixed to the first positioning section, and the fixing member is fixedly attached to the middle frame by a fastening member passing through the circlelike hole and fastened to the fastening hole.

4. The display device of claim 3, wherein the cut-out opening has a width greater than a thickness of the positioning member, and the circlelike hole has an elongated elliptical shape.

5. The display device of claim 4, wherein the positioning member is an upright plate, the positioning member is disposed vertically from the display panel toward the first surface, the first positioning section includes a through-hole, the second positioning section includes a protruding pillar, and the protruding pillar of the second positioning section is configured to be inserted into the through-hole of the first positioning section.

6. The display device of claim 5, wherein the fixing member has an L-shaped structure, the middle frame side fixing module includes an inclined surface section, the inclined surface section is disposed on the second plane, the inclined surface section gradually protrudes from the fastening hole toward the cut-out opening on the second surface, and a first end of the inclined surface section protruding from the second surface is parallel to a wall surface of the cut-out opening.

7. The display device of claim 6, wherein the fastening hole is formed in the inclined surface section and the fastening hole is adjacent to a second end of the inclined surface section, in which the second end is opposite to the first end.

8. The display device of claim 1, wherein the plurality of first fixed structure sets include at least three first fixed structure sets, and the at least three first fixed structure sets and the at least one second fixed structure set are disposed along four rectangular vertices.

9. A fixed structure set for fixing a display panel to a middle frame, the fixed structure set comprising:
a panel side fixing unit disposed on the display panel and including a positioning member, in which a first positioning section is formed at one end of the positioning member away from the display panel; and
a middle frame side fixing module disposed on the middle frame to correspond to the panel side fixing unit, wherein
the middle frame side fixing module includes a mounting portion and a fixing member, the positioning member and the fixing member are disposed on both sides of the mounting portion facing each other, respectively, and the fixing member fixes the first positioning section.

10. The fixed structure set of claim 9, wherein the mounting portion includes a cut-out opening and at least one fastening hole, in which the cut-out opening is formed to penetrate both surfaces of the middle frame to allow the positioning member to pass through, the at least one fastening hole is disposed on a surface of the middle frame away from the display panel and is adjacent to the cut-out opening, the fixing member has a second positioning section and a circlelike hole, the fixing member is disposed on the surface of the middle frame away from the display panel to correspond to the cut-out opening, the second positioning section is fixed to the first positioning section, and the fixing member is fixedly attached to the middle frame by a fastening member passing through the circlelike hole and fastened to the fastening hole.

11. The fixed structure set of claim 10, wherein the cut-out opening has a width greater than a thickness of the positioning member, and the circlelike hole has an elongated elliptical shape.

12. The fixed structure set of claim 11, wherein the positioning member is an upright plate, the positioning member is disposed vertically from the display panel toward the middle frame, the first positioning section includes a through-hole, the second positioning section includes a protruding pillar, and the protruding pillar of the second positioning section is configured to be inserted into the through-hole of the first positioning section.

13. The fixed structure set of claim 12, wherein the fixing member has an L-shaped structure, the middle frame side fixing module includes an inclined surface section, the inclined surface section is disposed on a surface of the middle frame away from the display panel, the inclined surface section gradually protrudes from the fastening hole toward the cut-out opening on the surface, and a first end of the inclined surface section protruding from the surface is parallel to a wall surface of the cut-out opening.

14. The fixed structure set of claim 13, wherein the fastening hole is formed in the inclined surface section and the fastening hole is adjacent to a second end of the inclined surface section, in which the second end is opposite to the first end.
